(19) United States
(12) Patent Application Publication
(10) Pub. No.: US 2008/0013634 A1
(43) Pub. Date: Jan. 17, 2008

(54) APPARATUS AND METHOD FOR HIGH-SPEED INTERFACING BETWEEN INTEGRATED CIRCUITS

(75) Inventors: Jin-Seok LEE, Seongnam-si (KR); Song-Hun Kim, Suwon-si (KR); Kwang-Yung Jeong, Yongin-si (KR); Min-Soo Jung, Yongin-si (KR); Soon-Ju Kim, Seoul (KR)

Correspondence Address: Jefferson IP Law, LLP, 1730 M Street, NW, Suite 807, Washington, DC, 20036, US

(73) Assignee: Samsung Electronics Co., LTD., Suwon-city (KR)

(21) Appl. No.: 11/774,747

(22) Filed: Jul. 9, 2007

(30) Foreign Application Priority Data
Jul. 14, 2006 (KR) 2006-0066291

(51) Int. Cl. H04L 27/00

(52) U.S. Cl. 375/256

(57) ABSTRACT

An apparatus and method for high-speed interfacing between ICs are provided. A generator generates space clock pulses by adjusting a data rate of data. An inserter inserts commas during the space clock pulses. And a transmitter transmits bit streams with the data and the commas to a receiving IC. Accordingly, data can be transmitted and received at high rates between ICs.

### PRIORITY

This application claims the benefit under 35 U.S.C. § 119(a) to a Korean patent application filed on Jul. 14, 2006 in the Korean Intellectual Property Office and assigned Serial No. 2006-66291, the entire disclosure of which is hereby incorporated by reference.

### BACKGROUND OF THE INVENTION

1. Field of the Invention

The present invention relates generally to an apparatus and method for high-speed interfacing between Integrated Circuits (ICs). More particularly, the present invention relates to an apparatus and method for high-speed communications between ICs by Low Voltage Differential Signaling (LVDS).

2. Description of the Related Art

In modern society, communication technologies provide convenience to users in many aspects of every day life. As the communication technologies find their applications in a wide range of fields, users' demands for high service quality are ever increasing. To meet the users' demands, the communication technologies are being developed to enable faster and more accurate data transmission and reception. Along with the developments of technologies, the data processing rate of hardware has been increased.

The hardware is designed with multiple ICs. High-speed data transmission/reception as well as high computation speed of the ICs is critical for high-speed data processing in the hardware. In this context, studies have been actively conducted on techniques for high-speed data communications between ICs, particularly on a serial data transmission scheme using a differential signaling-based transceiver with an internal clock.

Field Programmable Gate Array devices (FPGAs) are a kind of user-application specific and user-programmable ICs. Because of their benefits of short design cycle and easy modification, the FPGAs are widely used in hardware design. For high-speed data communications between FPGAs, FPGA manufacturers such as Altera and Xilinx have launched FPGA products with an embedded gigabit serial transmitter that can output data at 3.1875 Gbps per channel by LVDS.

FIGS. 1A and 1B are block diagrams of a conventional gigabit serial transceiver embedded in an FPGA.

FIG. 1A is a block diagram of a transmitter in the conventional gigabit serial transceiver embedded in the FPGA. Referring to FIG. 1A, a transmitter 10 includes a phase compensator 101, a byte serializer 103, an 8/10 encoder 105, a Parallel-to-Serial Converter (PSC) 107, and a transmission Phase Locked Loop (PLL) 109.

The phase compensator 101 receives bit streams with commas and data from a higher device and controls the phase of a clock signal superimposed on the bit streams in synchronization with an internal clock signal of the transmitter 10. A comma is an 8-bit character preset for synchronization between the transmitter 10 and a receiver. The bits of the bit streams are received in parallel at the phase compensator 101.

The byte serializer 103 serializes the bit streams received from the phase compensator 101 on a byte basis. For example, for the input of a parallel 16-bit bit stream, the byte serializer 103 outputs two 8-bit bit streams.

The 8/10 encoder 105 channel-encodes the 8-bit bit streams received from the byte serializer 103 at a coding rate of 8/10 by, for example, Cyclic Redundancy Checking (CRC). The PSC 107 converts the parallel bit streams received from the 8/10 encoder 105 to a serial bit stream.

The transmission PLL 109 converts the internal clock frequency loaded with the serial bit stream to a transmission clock frequency. The transmission clock frequency is determined according to data rate or the characteristics of an LVDS line 30. The transmission PLL 109 then transmits the bit stream to a receiving FPGA via the LVDS line 30.

FIG. 1B is a block diagram of a receiver in the conventional gigabit serial transceiver embedded in the FPGA. Referring to FIG. 1B, a receiver 20 includes a reception PLL 111, a clock generator 113, a Serial-to Parallel Converter (SPC) 115, a word arranger 117, an 8/10 decoder 119, a phase compensator 121, and a byte deserializer 123.

The reception PLL 111 receives a bit stream from a transmitting FPGA via the LVDS line 30.

The clock generator 113 extracts a clock signal from the bit stream received from the reception PLL 111 and converts the frequency of the clock signal to an internal clock frequency of the receiver 20. Since bit streams received via the LVDS line 30 include only commas and data without a clock signal, the clock generator 113 extracts a clock signal with a frequency and a phase corresponding to the received bit stream and then converts the frequency of the clock signal to the internal clock frequency, for operations of the following blocks.

The SPC 115 converts the serial bit stream received from the clock generator 113 to parallel bits.

The word arranger 117 outputs the parallel bits received from the SPC 115 in parallel 10-bit streams. For example, for the input of parallel 20 bits, the word arranger 117 outputs two parallel 10-bit bit streams.

The 8/10 decoder 119 decodes the parallel 10-bit bit streams at a coding rate of 8/10. If errors are detected during decoding the bit streams, the 8/10 decoder 119 notifies a higher device of the error detection. For example, if a bit stream has errors due to noise or physical defects in the transmission line, the 8/10 decoder 119 outputs a Sync Status signal set to 0, indicating an abnormal transmission status. The Sync Status signal is an error report signal by which the 8/10 decoder 119 indicates whether the received bit stream has errors to the higher device.

The phase compensator 121 adjusts the phase of the clock signal superimposed on the bit streams received from the 8/10 decoder 119 in synchronization with an internal clock signal of the receiver 20. The byte deserializer 123 parallelizes the parallel 8-bit (i.e. 1-byte) bit streams received from the phase compensator 121 according to a bit number suitable for an external transmission line.

In general, the gigabit serial transceiver embedded in the FPGA, having the above-described configuration, does not operate on a single channel. If the transceiver uses a single channel, it should use a very high clock frequency to achieve a target data rate. Therefore, it is typical to configure a plurality of channels by use of a plurality of transceivers in order to avoid the constraint of a very high clock frequency.

FIG. 2 is a diagram illustrating transmission and reception timings in the conventional serial gigabit transceiver.

Referring to FIG. 2, the transmitter 10 is configured so as to operate on four channels and transmits data 220 and commas 210 in phase with one another to the receiver 20. However, the receiver 20 receives the commas 210 and the data 220 out of phase due to different lines and statuses of the channels. Although the receiver 20 should synchronize the channels with one another in data output, it may occur that the transmitter 10 transmits successive data without any commas. In this case, the receiver 20 does not know how much the phase of each channel has been distorted because it cannot find the start of the data.

In addition to the commas 210 and the data 220, the receiver 20 receives garbage values 230. The receiver 20 considers the garbage values 230 to be data and outputs an unnecessary signal to a system, causing malfunction or an unnecessary operation to the system. The garbage values 230 are unnecessary bit streams received before the commas 210, when power is on in the transmitter 10 and the receiver 20.

In the process of separating a 16-bit bit stream into two 8-bit bit streams for 8/10 encoding in the transmitter and then combining the 8-bit bit streams into the 16-bit bit stream after 8/10 decoding in the receiver, a Most Significant Bit (MSB) can be swapped with a Least Significant Bit (LSB).

As described above, the conventional gigabit serial transceiver may not transmit and receive data normally due to asynchronization among channels, the absence of commas in the case of successive data transmission, output of garbage values, and MSB-LSB swapping in data.

### SUMMARY OF THE INVENTION

An aspect of the present invention is to address at least the above problems and/or disadvantages and to provide at least the advantages described below. Accordingly, an aspect of the present invention is to provide an apparatus and method for high-speed communications between ICs.

Another aspect of the present invention is to provide an apparatus and method for acquiring data output synchronization between channels in a gigabit serial receiver embedded in an IC.

A further aspect of the present invention is to provide an apparatus and method for inserting commas in successive input data in a gigabit serial transmitter embedded in an IC.

Still another aspect of the present invention is to provide an apparatus and method for preventing output of garbage values in a gigabit serial receiver embedded in an IC.

Yet another aspect of the present invention is to provide an apparatus and method for correcting data with MSBs swapped with LSBs in a gigabit serial receiver embedded in an IC.

According to one aspect of the present invention, an apparatus for high-speed interfacing between ICs is provided. The apparatus includes a generator for generating space clock pulses by adjusting a data rate of data, an inserter for inserting commas during the space clock pulses, and a transmitter for transmitting bit streams with the data and the commas to a receiving IC.

According to another aspect of the present invention, an apparatus for high-speed interfacing between ICs is provided. The apparatus includes a receiver for receiving bit streams from a transmitting IC, a detector for detecting commas in the received bit streams and a synchronizer for acquiring data output synchronization among channels using the commas.

According to a further aspect of the present invention, a method for high-speed interfacing between ICs is provided. The method includes generating space clock pulses by adjusting a data rate of data, inserting commas during the space clock pulses and transmitting bit streams with the data and the commas to a receiving IC.

According to still another aspect of the present invention, a method for high-speed interfacing between ICs is provided. The method includes receiving bit streams from a transmitting IC, detecting commas in the received bit streams and acquiring data output synchronization among channels using the commas.

### BRIEF DESCRIPTION OF THE DRAWINGS

The above and other objects, features and advantages of certain exemplary embodiments of the present invention will become more apparent from the following detailed description when taken in conjunction with the accompanying drawings in which:

FIGS. 1A and 1B are block diagrams illustrating a conventional gigabit serial transceiver embedded in an FPGA;

FIG. 2 is a diagram illustrating transmission and reception timings in the conventional serial gigabit transceiver;

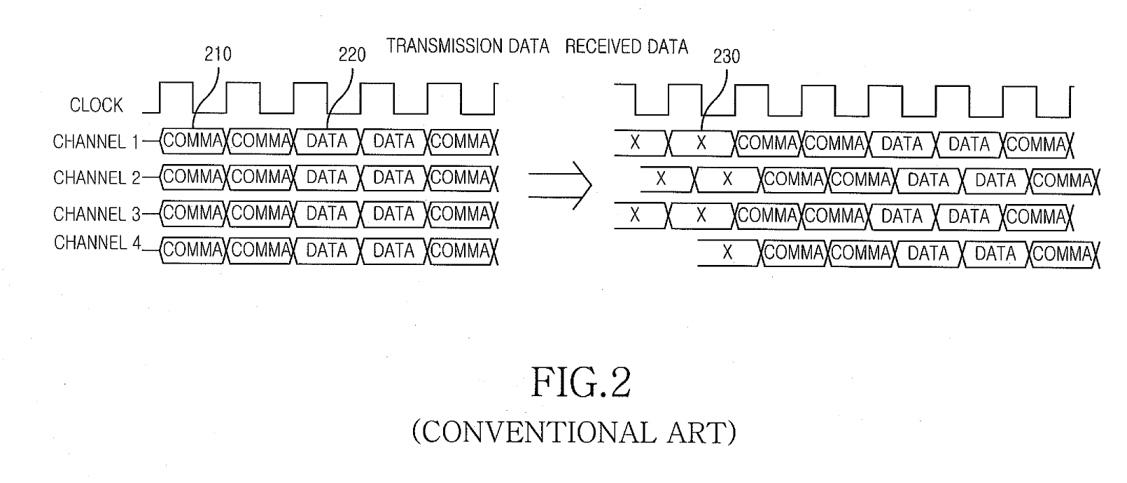

FIGS. 3A and 3B are block diagrams illustrating a transceiver in an FPGA according to an exemplary embodiment of the present invention;

FIG. 4 is a block diagram illustrating a space generator in the transceiver illustrated in FIG. 3A according to an exemplary embodiment of the present invention;

FIG. 5 illustrates comma insertion in the FPGA according to an exemplary embodiment of the present invention;

FIG. 6 is a flowchart illustrating a data transmission operation in a transmitter of the transceiver illustrated in FIG. 3A according to an exemplary embodiment of the present invention; and

FIG. 7 is a flowchart illustrating a data reception operation in a receiver of the transceiver illustrated in FIG. 3B according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the present invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, description of well-known functions and constructions are omitted for clarity and conciseness.

The present invention provides a technique for high-speed data interfacing between programmable ICs such as FPGAs, Complex Programmable Logic Devices (CPLDs), and the like by using gigabit serial transceivers embedded in the programmable ICs. More particularly, the present invention provides a technique for synchronizing between channels, inserting commas, preventing output of garbage values, and correcting swapped data during data transmission/reception between ICs. The following description is made in the context of an interface between FPGAs, by way of example.

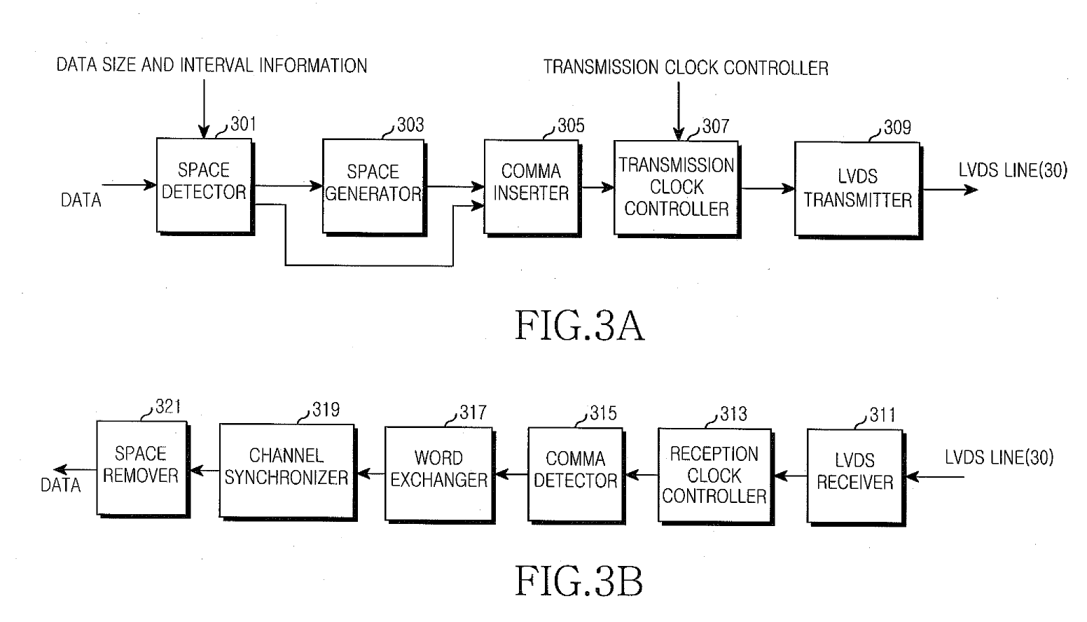

FIGS. 3A and 3B are block diagrams illustrating a transceiver in an FPGA according to an exemplary embodiment of the present invention.

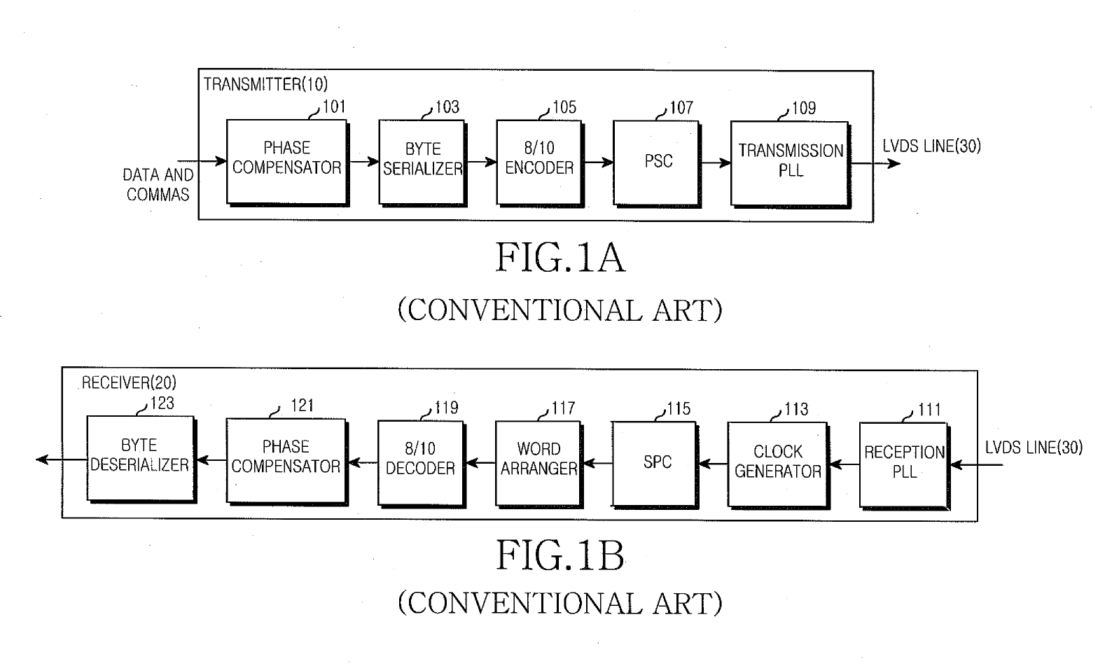

FIG. 3A is a block diagram illustrating a transmitter of the transceiver in the FPGA according to an exemplary embodiment of the present invention. Referring to FIG. 3A, the transmitter includes a space detector 301, a space generator 303, a comma inserter 305, a transmission clock controller 307, and an LVDS transmitter 309. The LVDS transmitter 309 is substantially identical to the transmitter 10 illustrated in FIG. 1A.

The space detector 301 determines whether there is any space in data streams received from a higher device based on information about a data size and an interval received from a higher controller, such as a Central Processing Unit (CPU), and switches an input path for the data streams according to the presence or absence of space. If the data streams have successive data without any space, the space detector 301 provides the data streams to the space generator 303. If the data streams include spaces, the space detector 301 provides the data streams to the comma inserter 305.

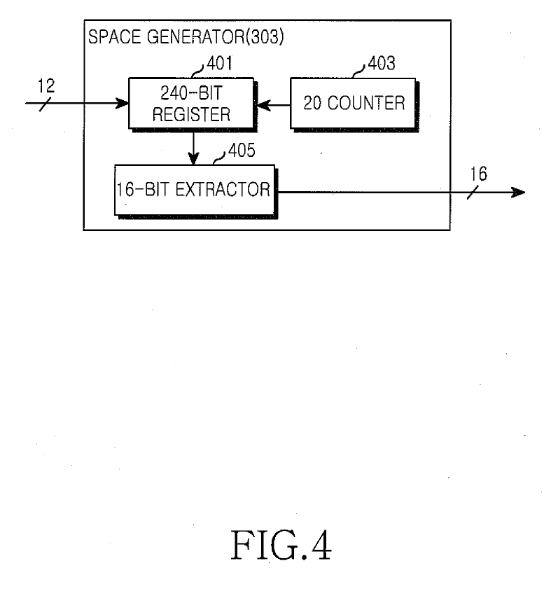

The space generator 303 generates a space clock signal to insert commas into the space-free successive data streams by allocating fewer clock pulses than inputs to outputs using more output buses than input buses. For example, as illustrated in FIG. 4 the space generator 303 can include a 240-bit register 401, a 20 counter 403, and a 16-bit extractor 405. The 240-bit register 401 stores 20 (=240/12) 12-bit data streams and outputs the stored data on a 16-bit-by-16-bit basis in a first-input first-output order. The 20 counter 403 increases its count by 1 each time, 12 bits are input to the 240-bit register 401 in order to determine the time of outputting the stored data from the 240-bit register 401. The 16-bit extractor 405 extracts data from the 240-bit register 401 on a 16-bit-by-16-bit basis, starting when the count reaches 6, and outputs the extracted data in parallel. Thus, the space generator 303 can output data received for 20 clock pulses in accordance with 15 clock pulses by outputting 12-bit input data in 16 bits. That is, the space generator 303 receives 20 12-bit data streams for 20 clock pulses and outputs 15 16-bit data streams for 15 clock pulses, thereby creating 5 space clock pulses.

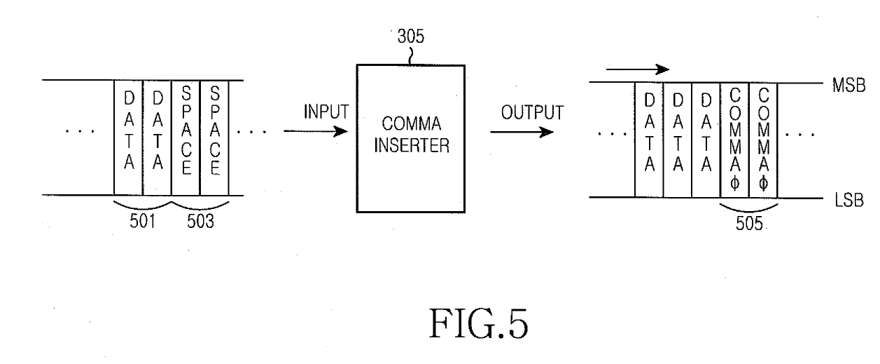

The comma inserter 305 inserts commas in spaces included in the bit streams received from the space generator 303 or the space detector 301. The commas are inserted in a pattern agreed between the transmitter and a receiver such that the receiver can determine whether MSBs and LSBs of data are swapped. As illustrated in FIG. 5, for example, when receiving data 501 and spaces 503, the comma inserter 305 inserts commas 505 in the spaces 503. Notably, the comma inserter 305 inserts the commas 505 only in MSBs of bit streams so that the receiver can determine from the insertion pattern of the commas 505 whether MSBs of data are swapped with LSBs of the data. The comma insertion pattern may vary depending on design.

The transmission clock controller 307 converts a system clock frequency loaded with the bit streams received from the comma inserter 305 to an internal clock frequency of the LVDS transmitter 309. Because the LVDS transmitter 309 operates based on its internal clock signal, the transmission clock controller 307 converts the system clock frequency loaded with the input bit streams to the internal clock frequency. The transmission clock controller 307 uses input and output clock information received from the higher controller (e.g. CPU) in clock adjustment.

The LVDS transmitter 309 encodes the bit streams received from the transmission clock controller 307 at a coding rate of 8/10, serializes the coded bit streams, and transmits the serial bit stream to a receiving FPGA via the LVDS line 30.

FIG. 3B is a block diagram of a receiver of the transceiver in the FPGA according to an exemplary embodiment of the present invention. Referring to FIG. 3B, the receiver includes an LVDS receiver 311, a reception clock controller 313, a comma detector 315, a word exchanger 317, a channel synchronizer 319, and a space remover 321. The LVDS receiver 311 is substantially identical to the receiver 20 illustrated in FIG. 1B.

The LVDS receiver 311 processes a bit stream received from a transmitting FPGA by serial-to-parallel conversion and 8/10 decoding. The resulting bit streams are output, loaded in an internal clock frequency of the LVDS receiver 311.

The reception clock controller 313 converts the internal clock frequency of the bit streams received from the LVDS receiver 311 to a system clock frequency.

The comma detector 315 separates the bit streams received form the reception clock controller 313 into commas and data. Notably, the commas always precede the data in the bit streams. Thus, the comma detector 315 does not output received bit streams until receiving the commas after power is on in the transceiver in order to prevent output of garbage values. Also, the comma detector 315 monitors an error report signal received from the 8/10 decoder 119 in the LVDS receiver 311. If errors are detected in the received data, the comma detector 315 notifies the transmitting FPGA of the error detection, discontinuing data output.

The word exchanger 317 exchanges MSBs with LSBs in data with the MSBs swapped with the LSBs, if the comma insertion pattern of the bit streams received from the comma detector 315 is different from a preset comma insertion pattern.

The channel synchronizer 319 evaluates the phases of commas in the bit streams received from the word exchanger 317 and if the commas are out of phase between channels, it stores data following the comma on each channel. When the data of all channels are completely stored, the channel synchronizer 319 outputs the data simultaneously.

The space remover 321 removes space clock pulses generated for comma insertion from the bit streams received from the channel synchronizer 319.

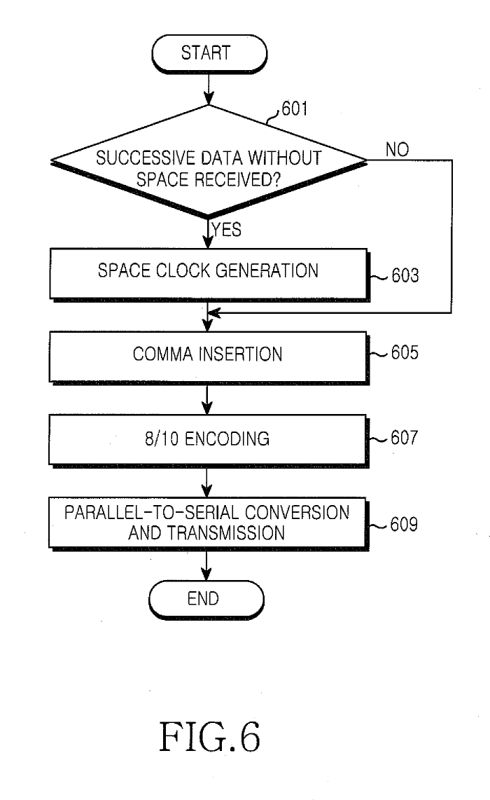

FIG. 6 is a flowchart illustrating a data transmission operation in the transmitter of the transceiver illustrated in FIG. 3A according to an exemplary embodiment of the present invention.

Referring to FIG. 6, the transmitter monitors reception of successive data without any space from a higher device in step 601.

Upon receipt of successive data without any space, the transmitter generates space clock pulses for comma insertion in step 603. Since the receiver cannot synchronize between channels using the data without commas, the transmitter generates the space clock pulses to insert commas into the successive data.

In step 605, the transmitter inserts commas during the space clock pulses in a pattern, which is preset between the transmitting side and the receiving side so as to correct data block swapping. For example, the transmitter inserts a comma 505 only in MSBs of an output bit stream, as shown in FIG. 5, so that the receiver can be aware of MSB-LSB swapping in the data by checking the comma insertion pattern, if the MSB-LSB swapping occurs.

In step 607, the transmitter divides the bit streams on a byte basis and encodes the 8-bit bit streams to 10-bit bit streams by, for example, CRC, for error check in the receiver.

The transmitter serializes the coded bit streams and transmits the serial bit stream to a receiving FPGA via the LVDS line in step 609.

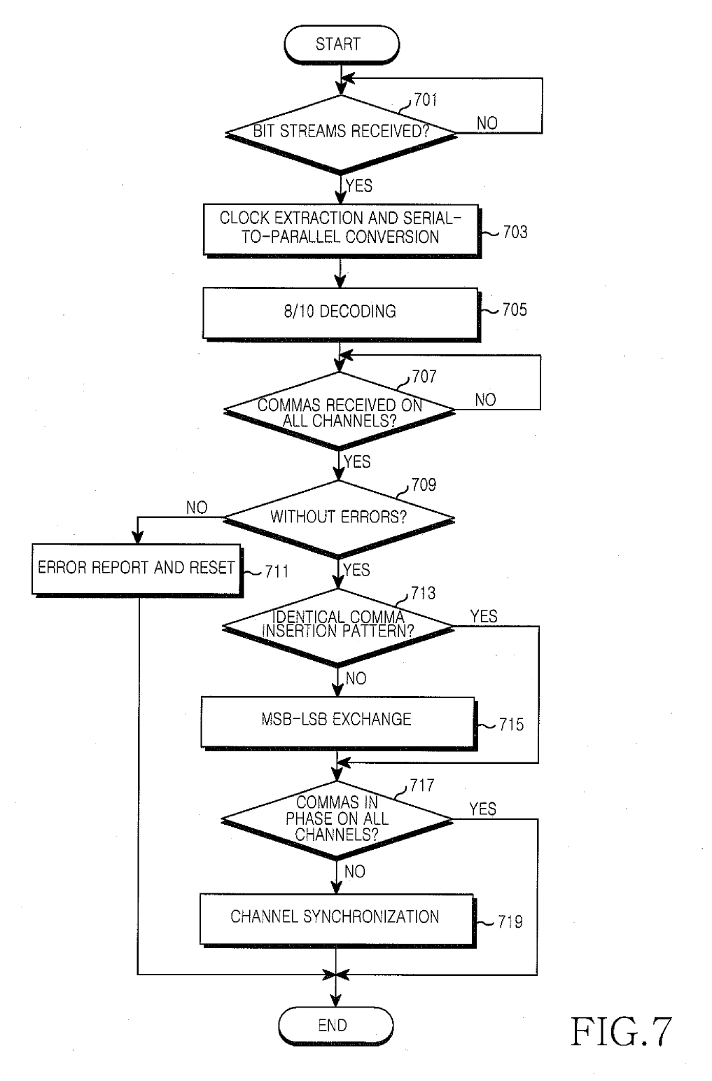

FIG. 7 is a flowchart illustrating a data reception operation in the receiver of the transceiver illustrated in FIG. 3B according to an exemplary embodiment of the present invention.

Referring to FIG. 7, the receiver monitors reception of bit streams from a transmitting FPGA via the LVDS line in step 701.

Upon receipt of the bit streams, the receiver extracts a clock signal from the bit streams and parallelizes the bit streams in step 703.

The receiver divides the bit streams on a 10-bit basis and decodes the 10-bit bit streams to 8-bit bit streams in step 705. If errors are detected during decoding a data block, the receiver sets an error report signal Sync Status to 0.

In step 707, the receiver determines whether commas are received on every channel. That is, the receiver blocks a data flow until commas are received on all channels in order to prevent output of garbage values preceding the commas. This operation amounts to deactivating the output of the comma detector 315.

Upon receipt of commas on all channels, the receiver determines whether the received data has errors by checking whether Sync Status is 1 in step 709. In the presence of errors in the data, i.e. if Sync Status is 0, the receiver reports the error detection to a transmitting FPGA and is reset in step 711. Then the algorithm of the exemplary embodiment ends.

In contrast, in the absence of errors, i.e. if Sync Status is 1, the receiver determines whether the comma insertion pattern of the data is normal in step 713. The comma insertion pattern is preset between the transmitting side and the receiving side, for use in detecting MSB-LSB swapping in data at the receiving side. For example, if the transmitting and receiving sides agree that a comma is inserted only in MSBs of a comma bit stream as illustrated in FIG. 5, the receiving side checks whether a comma is present in MSBs of a received comma bit stream.

If the comma insertion pattern is not normal, that is, a comma does not exist in the MSBs of a received comma bit stream, the receiver exchanges the MSBs with the LSBs of the comma bit stream in step 715.

In step 717, the receiver determines whether commas are in phase on all channels.

If the commas are out of phase on the channels, the receiver synchronizes data outputs of the channels with one another in step 719. Specifically, the receiver stores data following the commas for all channels in a buffer and outputs the data simultaneously, thereby acquiring data output synchronization among the channels.

In accordance with certain exemplary embodiment of the present invention as described above, interfaces are added to an input end of a gigabit serial transmitter embedded in an IC and an output end of a gigabit serial receiver embedded in the IC, for synchronization among channels, comma insertion, prevention of garbage value output, and correction of swapped data. Therefore, data can be transmitted and received at high rates between ICs.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An apparatus for high-speed interfacing between Integrated Circuits (ICs), comprising:
a generator for generating space clock pulses by adjusting a data rate of data;
an inserter for inserting commas during the space clock pulses; and
a transmitter for transmitting bit streams with the data and the commas to a receiving IC.

2. The apparatus of claim 1, wherein the generator comprises:
a register for sequentially storing input data via N buses; and
an extractor for outputting the stored data from the register via at least (N+1) buses.

3. The apparatus of claim 2, wherein the generator further comprises:
a counter for determining a time to output the stored data from the register, wherein the generator stores data received via the N buses for part of a time period, and stores data received via the N buses and simultaneously outputs the stored data via the (N+1) buses for a remaining part of the time period.

4. The apparatus of claim 1, wherein the inserter inserts a comma in at least one of upper bits and lower bits.

5. The apparatus of claim 1, wherein the transmitter encodes the bit streams and serializes the coded bit streams.

6. The apparatus of claim 1, wherein the transmitter comprises a Low Voltage Differential Signaling (LVDS) transmitter.

7. The apparatus of claim 6, wherein the inserter is positioned at a front end of the LVDS transmitter.

8. The apparatus of claim 1, wherein the ICs comprise at least one of Field Programmable Gate Arrays (FPGAs) and Complex Programmable Logic Devices (CPLDs).

9. An apparatus for high-speed interfacing between Integrated Circuits (ICs), comprising:
a receiver for receiving bit streams from a transmitting IC;
a detector for detecting commas in the received bit streams; and
a synchronizer for acquiring data output synchronization among channels using the commas.

10. The apparatus of claim 9, wherein the receiver decodes the received bit streams and outputs an error report signal indicating error detection to the detector, if errors are detected in the received bit streams.

11. The apparatus of claim 9, wherein the detector monitors an error report signal received from the receiver and if the error report signal indicates error detection, feeds back information indicating the error detection to a transmitting IC.

12. The apparatus of claim 9, wherein the detector outputs the received bit streams to the synchronizer, if the commas are received on all of the channels, upon power-on of the receiver.

13. The apparatus of claim 9, wherein the synchronizer stores data following the commas on the channels, if the commas on the channels are out of phase, and simultaneously outputs the data of the channels.

14. The apparatus of claim 9, further comprising an exchanger for exchanging upper bits of received data with lower bits of the received data, if a comma insertion pattern of the commas is different from a predetermined comma insertion pattern.

15. The apparatus of claim 9, wherein the receiver comprises a Low Voltage Differential Signaling (LVDS) receiver.

16. The apparatus of claim 9, wherein the ICs comprise at least one of Field Programmable Gate Arrays (FPGAs) and Complex Programmable Logic Devices (CPLDs).

17. A method for high-speed interfacing between Integrated Circuits (ICs), comprising:
generating space clock pulses by adjusting a data rate of data;
inserting commas during the space clock pulses; and
transmitting bit streams with the data and the commas to a receiving IC.

18. The method of claim 17, wherein the generating of the space clock comprises:
sequentially storing input data via N buses; and
outputting the stored data from the register via at least (N+1) buses.

19. The method of claim 18, wherein the adjusting of the data rate comprises:
storing data received via the N buses for part of a time period; and
storing data received via the N buses and simultaneously outputting the stored data via the (N+1) buses for a remaining part of the time period.

20. The method of claim 17, wherein the inserting of the commas comprises inserting a comma in at least one of upper bits and lower bits.

21. The method of claim 17, wherein the transmitting of the bit streams comprises:
encoding the bit streams;
serializing the coded bit streams; and
transmitting the serial bit stream.

22. The method of claim 17, wherein the transmitting of the bit streams comprises transmitting the bit streams by Low Voltage Differential Signaling (LVDS).

23. The method of claim 17, wherein the ICs comprise at least one of Field Programmable Gate Arrays (FPGAs) and Complex Programmable Logic Devices (CPLDs).

24. A method for high-speed interfacing between Integrated Circuits (ICs), comprising:
receiving bit streams from a transmitting IC;
detecting commas in the received bit streams; and
acquiring data output synchronization among channels using the commas.

25. The method of claim 24, further comprising outputting the received bit streams, if the commas are received on all of the channels, upon power-on.

26. The method of claim 24, wherein the acquiring of the data output synchronization comprises:
determining whether the commas are in phase on the channels;
storing data following the commas on the channels, if the commas on the channels are out of phase; and
simultaneously outputting the data of the channels.

27. The method of claim 24, further comprising:
decoding the received bit streams, upon receipt of the bit streams from the transmitting IC and checking errors in the decoded bit streams; and
feeding back information indicating the error detection to the transmitting IC.

28. The method of claim 24, further comprising:
comparing a comma insertion pattern of the commas with a predetermined comma insertion pattern; and
exchanging upper bits of received data with lower bits of the received data, if the comma insertion pattern of the commas is different with the predetermined comma insertion pattern.

29. The method of claim 24, wherein the receiving of the bit streams comprises receiving the bit streams by Low Voltage Differential Signaling (LVDS).

30. The method of claim 24, wherein the ICs comprise at least one of Field Programmable Gate Arrays (FPGAs) and Complex Programmable Logic Devices (CPLDs).
